(19) United States
(12) Patent Application Publication
(10) Pub. No.: US 2010/0084202 A1
(43) Pub. Date: Apr. 8, 2010

(54) ERGONOMIC STYLUS PEN AND RESERVOIR THEREFOR

(75) Inventors: Markus Samuel SELIN, Sundbyberg (SE); Donato PASQUARIELLO, Vasteras (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/245,094

(22) Filed: Oct. 3, 2008

(51) Int. Cl. G06F 3/033

(52) U.S. Cl. 178/19.01

(57) ABSTRACT

The present invention provides a stylus member and a corresponding portable communication device. The stylus member comprises at least one electro-active polymer (EAP) unit that is adapted to change in size so as to enable the portable communication device to receive the stylus member in a housing provided therefor. Means for locking the stylus member in the housing as well as means for releasing the stylus member are also provided in the portable communication device. By providing at least one EAP unit in the stylus member, it may adopt an ergonomic shape facilitating the usage of the stylus pen, for instance when activating a pressure-sensitive screen or display of a portable communication device. This invention may provide an ergonomic stylus pen that can be ejected from a portable communication device upon detecting user input, such as detecting pressing of a button.

### TECHNICAL FIELD

The present invention relates in general to stylus pens and reservoir therefor, in particular to ergonomic stylus pens and their reservoirs.

### BACKGROUND

Stylus pens have become common in mobile phones after the introduction of pressure sensitive screens and displays. Usually the stylus pen can be housed within the mobile phone.

As the number of units to be fitted in mobile phones increases, the space available for each such unit decreases. For this reason, stylus pen have become more and more difficult to fit into mobile phones.

Telescopic stylus pens have therefore been proposed, which pens may be pushed together and shortened before or at the time of insertion of the stylus pen into the mobile phone.

Another attempt to fit a stylus pen inside a mobile phone has been to provide a especially thin stylus pen, wherein the pen for this reason occupies a smaller amount of space in the mobile phone.

However, smaller and thinner stylus pens often become less comfortable to use. Providing a stylus pen that is uncomfortable and difficult to operate prevents a proper usage of the pen and therefore also the mobile phone.

The user's experience of the entire mobile phone is negatively affected and it becomes less attractive to the consumer.

There is hence a need for providing an improved stylus pen and a reservoir therefor, which are attractive to the user.

### SUMMARY

An object of the present invention is to provide an ergonomic stylus member and a corresponding portable communication device, in which the stylus member is adapted to be received.

According to the first aspect of the present invention, there is provided a stylus member for a portable communication device, said stylus member comprising:

a body portion being elongated along an elongation axis, and
at least a first electro-active polymer (EAP) portion arranged at said body portion, said
at least first EAP portion comprising an EAP unit comprising an electro-active polymer,
a first electrode, and a second electrode, wherein the first and second electrodes flank the EAP,
wherein the body portion of the stylus member further comprises an electric conductor connecting the first electrode of the EAP unit and a first electric contact of the body portion of the stylus member,
and wherein the EAP unit is adapted to change in size upon application of an electric voltage over the first and second electrodes of the EAP unit.

The EAP unit of the stylus member according to the first aspect may further be arranged to contract in the direction perpendicular to the elongation axis of the stylus member, upon application of the electric voltage.

The stylus member according to the first aspect may further comprise locking means adapted to lock the stylus member in a housing provided therefor.

The stylus member according to the first aspect may further comprise releasing means adapted to release a locked stylus member from the housing provided therefor.

The locking means of the stylus member according to the first aspect may further comprise an EAP unit that is rigidly mounted on the stylus member and arranged to protrude in a direction perpendicular to the elongation axis of the stylus member, upon application of the electrical voltage.

The stylus member according to the first aspect may further comprise ejecting means adapted to eject the stylus member from a housing provided therefor.

The ejecting means of the stylus member according to the first aspect may further comprise an EAP unit that is arranged to expand from a contracted EAP state, upon disconnection of an electrical voltage over said EAP unit.

The stylus member according to the first aspect may be a stylus pen.

According to a second aspect of the present invention, there is provided a portable communication device comprising:

an outer surface, and
an inner surface forming an elongated housing, wherein said inner surface comprises at least a first electrode,
wherein the inner surface further comprises a second electrode, and wherein the first and second electrodes are arranged to be connected to a first and a second pole,
respectively, of an electric voltage supply, and wherein the housing, as formed by the inner surface, is adapted to receive a stylus member according to the first aspect of the present invention.

The portable communication device of the second aspect may further contacting means for contracting a stylus member upon insertion of the stylus member according to the first aspect of the present invention, said means comprising a first electrode, a second electrode and an electric voltage supply, and wherein the first and second electrodes are adapted to contact the first electric contact of the body portion and the second electrode of the EAP unit, respectively.

The portable communication device of the second aspect may further comprise ejecting means adapted to eject a stylus member according to the first aspect of the present invention.

The ejecting means of the portable communication device of the second aspect may comprise at least one electrically conducting sloping wall and an electrical switch adapted to disconnect the electrical voltage supply from the EAP unit, as initiated by a user of the portable communication device, such that the EAP unit upon relaxation pushes towards the at least one electrically conducting sloping wall, thereby obtaining a force directed towards the entrance of the housing, forcing the stylus member according to the first aspect of the present invention, to eject from the housing.

The ejecting means of the portable communication device of the second aspect may comprise a compressing spring ejecting the stylus member according to the first aspect of the present invention, from the housing.

The portable communication device of the second aspect may further comprise locking means adapted to lock a stylus member according to the first aspect of the present invention, upon insertion of the stylus member into the housing.

The locking means of the portable communication device of the second aspect may comprise an indentation in the inner surface, said indentation being adapted to receive the protrusion of the stylus member according to the first aspect of the present invention.

The portable communication device of the second aspect may further be a mobile phone.

It should be emphasized that the term “comprises/comprising” when being used in the specification is taken to specify the presence of the stated features, integers, or components but does not preclude the presence or addition of one or more other features, integers, or components or groups thereof.

### BRIEF DESCRIPTION OF THE DRAWINGS

In order to explain the invention and the advantages and features thereof in more detail, embodiments will be described below, references being made to the accompanying drawings, in which

FIGS. 1A and 1B are schematic representations of an electro-active polymer (EAP) device according to prior art;

FIGS. 2A and 2B are schematic representations of an EAP device provided in a rigid frame according to prior art;

FIG. 3 is schematic presentation of a stylus pen system;

FIGS. 4A and 4B are schematic lateral presentations of a stylus pen according to a first embodiment of the present invention;

FIGS. 4C and 4D are schematic axial presentations of a stylus pen according to a first embodiment of the present invention;

FIGS. 5A and 5B are schematic lateral presentations of a portable communication device and a stylus pen, further illustrating the first embodiments of the present invention;

FIGS. 6A, 6B and 6C, are schematic lateral presentations of a portable communication device and a stylus pen, illustrating a second embodiment of the present invention;

FIGS. 7A, 7B and 7C, are schematic lateral presentations of a portable communication device and a stylus pen, illustrating a third embodiment of the present invention;

FIGS. 8A, 8B and 8C, are schematic lateral presentations of a portable communication device and a stylus pen, illustrating a fourth embodiment of the present invention;

FIGS. 9A, 9B and 9C, are schematic lateral presentations of a portable communication device and a stylus pen, illustrating a fifth embodiment of the present invention;

FIGS. 10A, 10B and 10C, are schematic lateral presentations of a of portion of a portable communication device and a stylus pen, illustrating a sixth embodiment of the present invention;

FIGS. 11A, 11B, 11C and 11D, are schematic lateral presentations of a portable communication device and a stylus pen, illustrating a seventh embodiment of the present invention;

FIGS. 12A, 12B, 12C and 12D, are schematic lateral presentations of a portable communication device and a stylus pen, illustrating an eighth embodiment of the present invention; and

FIG. 12E is a schematic illustration of a lateral cross-section of a stylus member.

### DETAILED DESCRIPTION

Mobile phones having a pressure sensitive screen or display are often delivered with a stylus pen that may be stored inside the mobile phone.

The smaller the mobile phones become the more difficult it gets to provide enough space within the mobile phone to receive the stylus pen.

The present invention is directed towards providing various stylus pens that are arranged to change their shape upon insertion of stylus pen into a reservoir, such as a mobile phone.

The following invention provides various embodiments of how to provide a stylus member that may be stated to be ergonomic, and that may be received in a housing in a portable communication device, such as a mobile phone, seemingly too small to house said stylus member.

For this reason electro-active polymers (EAPs) are provided in stylus pens. Such a stylus pen may namely change its shape upon insertion into a housing of a mobile phone.

Electro-active polymers (EAPs) are characterised by their ability to change shape in response to electrical stimulation. The EAPs may be categorised in two major groups, one being electrostatic EAPs, and the other being ionic EAPs. The electro static EAPs of today typically require a voltage of the order of kilo volts to generate a substantial shape change, the ionic EAPs currently available show shape changes as a response to voltages of the order of volts.

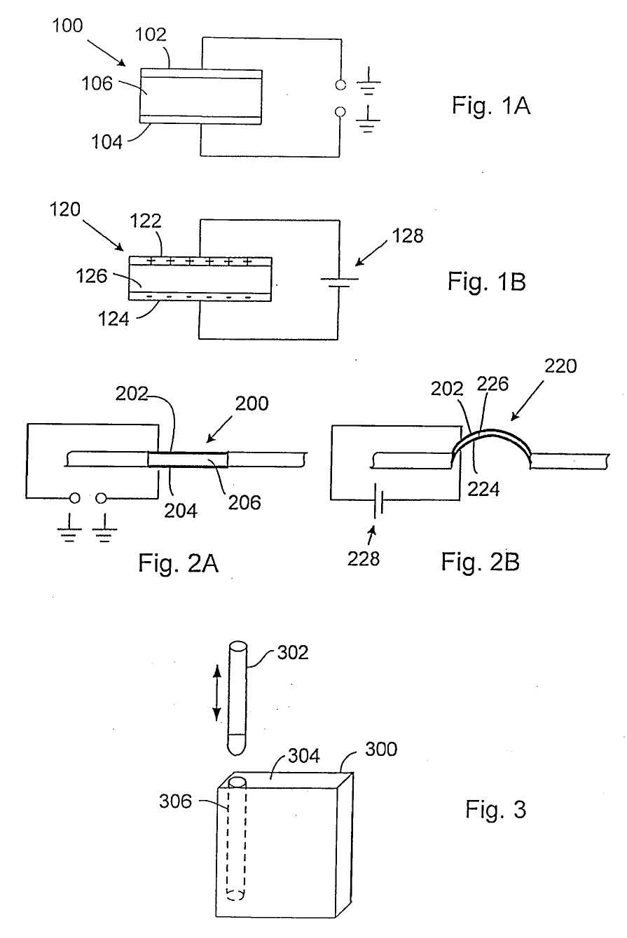

FIGS. 1A and 1B presents an electro-active polymer (EAP) device 100, 120 according to the prior art. In FIG. 1A the EAP device 100 comprises an upper electrode 102, a lower electrode 104 and an EAP portion 106. The upper and lower electrodes 102, 104 are arranged opposite in relation to one another, surrounding the EAP portion 106.

In FIG. 1B, an EAP device 120 is shown, to which an electric voltage from a electric voltage supply 128 has been applied between an upper electrode 122 and a lower electrode 124. The two electrodes 122 and 124 surround the EAP portion 126, providing an electric field across the EAP causes a shape change of the EAP. The EAP device 120 typically shrinks in the direction of the electric field lines between the two electrodes 122 and 124, whereas the EAP device 120 typically expands in a direction perpendicular to the electric field lines. The EAP device 120 may thus expand in a direction parallel with the electrodes 122 and 124, as a consequence of the applied electric voltage from the electric voltage supply 128.

FIGS. 2A and 2B present an electro-active polymer (EAP) device 200, 220 provided in a rigid frame, according to the prior art. The EAP device 200 of FIG. 2A is comprises an upper electrode 202, a lower electrode 204 and an EAP portion 206. The upper and lower electrodes 202, 204 are arranged opposite in relation to one another, surrounding the EAP portion 206. In FIG. 2A no voltage is applied between the upper electrode 202 and the lower electrode 204. The EAP device 200 remains unchanged in size and shape.

In FIG. 2B however, an electric voltage has been applied between the upper electrode 222 and the lower electrode 224 surrounding the EAP portion 226, from an electric voltage supply 228. The applied electric voltage causes the EAP device 220 to attempt to expand in the plane of the rigid frame. Since the polymer is provided within a frame that is rigid, the polymer is prevented to expand within the plane of the rigid frame. The polymer device 220 therefore protrudes perpendicular to the rigid frame to cause a diaphragm. The EAP portion 226 between the two electrodes is hence contracted causing the EAP device 220 to adopt a thinner form having a curvature.

FIG. 3 presents a schematic presentation of a portable communication device 300 and a stylus pen 302. The portable communication device 300 comprises an outer wall 304 and an inner wall 306, wherein the inner wall forms a cavity for receiving the stylus pen. The stylus pen 302 is adapted to be used when activating a pressure-sensitive display or screen of the portable communication device 300.

The stylus pen 302 may be elongated along an elongation axis, and may thus be arranged to be housed in a housing defined by the inner wall 306 forming the cavity of the portable communication device 300, when not in use by a user. The stylus pen is thus also arranged to come out of the cavity.

The stylus pen 302 may be arranged to be pulled out by the user. The stylus pen may also be arranged to be ejected by ejecting means of the portable communication device 300. Other ways or means to empty the housing may also be provided for.

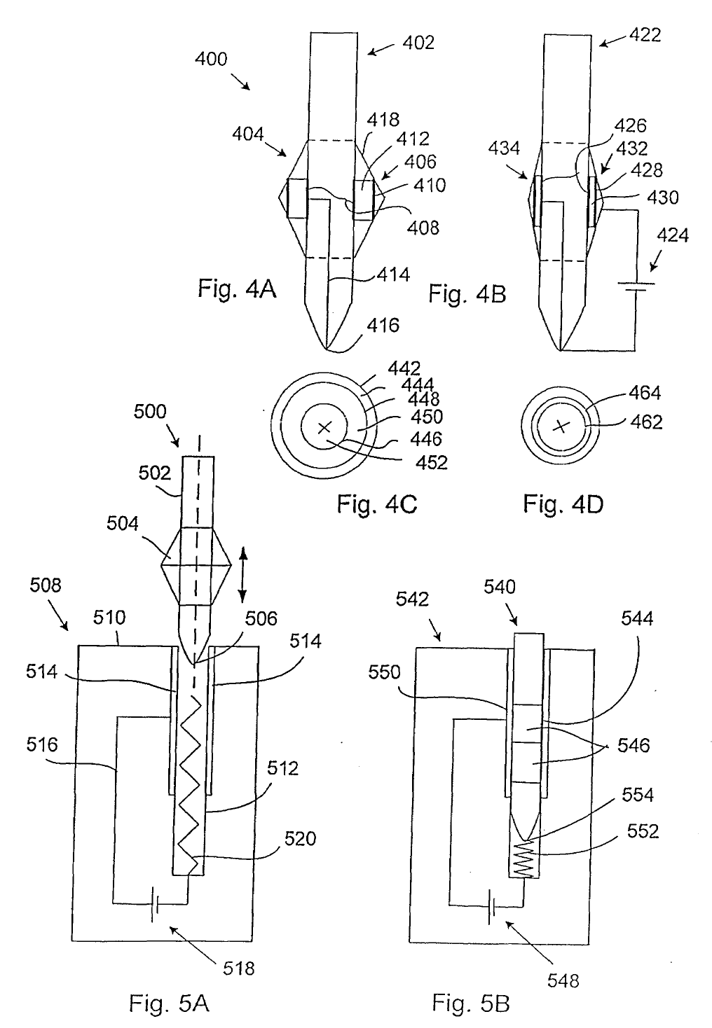

With reference to FIGS. 4A-4D a first embodiment of a stylus pen and a portable communication device is now presented.

According to this embodiments the stylus pen 400 may comprise a first portion 402 and a second portion 404, where the first portion 402 may be elongated along an elongation axis. The second portion 404 of the stylus pen 400 may comprise an electro-active polymer unit 406. This EAP unit 406 may comprise a first electrode 408, a second electrode 410 and an EAP 412, wherein the EAP is arranged in between the first 408 and second 410 electrodes, which two electrodes therefore flank the EAP 412.

As shown in FIG. 4A, an electric conductor 414 may be is connected between the first electrode 408 and the bottom tip 416 of the stylus pen 400. The second portion 404 may furthermore be covered by an electricity conducting film 418, which electricity conducting film 418 may therefore be in electrical contact with the second electrode 410 of the EAP unit 406. This arrangement of the stylus pen enables electrical contact between the bottom tip 416 of the stylus pen 400 and the electricity conducting film 418.

FIG. 4B presents the stylus pen 422 of FIG. 4A upon applying an electric voltage from an electric voltage supply 424. The electric voltage is applied over the first electrode 426 and second electrode 428 flanking the EAP portion 430. As the electric voltage is applied over the EAP unit 432, the polymer unit changes its shape by reacting in thickness by contractions in a direction perpendicular to the first 426 and second 428 electrodes. The EAP unit also reacts by length and area expansion in the plane of the first and second electrodes. The thickness contraction is an effect of the attraction forces between the first 426 and second 428 electrodes upon application of the electric voltage over said two electrodes 426, 428.

It is thus described that the EAP unit 432 can contract in the direction perpendicular to an elongation axis of the stylus member.

As explained above and as illustrated in FIG. 4B, the thickness of the EAP decreases. As a result the second portion 434 of the stylus pen contracts and the width of the stylus pen decreases.

FIGS. 4C and 4D further illustrate the shape change of an EAP unit upon application of an electric voltage. In more particular, FIG. 4C presents an axial view of the stylus pen of FIG. 4A, whereas FIG. 4D presents an axial view of the stylus pen of FIG. 4B. In FIG. 4C, the outermost ring 442 shows the width, i.e. the largest diameter of the second portion, 404 in FIG. 4A, comprising the EAP unit. The electricity conducting film 418 from FIG. 4A is shown in FIG. 4C as 444 covering the second portion of the stylus pen. The first electrode of the EAP unit is denoted with 446, whereas the second electrode and the electro-active polymer itself, are denoted by 448 and 450. The first elongated portion of the stylus pen is denoted by 452.

In FIG. 4C is the electro-active polymer (EAP) presented in its relaxed state, due to the absence of an electric voltage applied over the first 446 and second 448 electrodes.

FIG. 4D similarly presents the contracted stylus pen for which the EAP unit is contracted. This contraction is effected in the radial direction of the stylus pen, i.e. perpendicular to the elongation axis of the stylus pen. It is clearly shown that the first electrode 462 and second electrode 464 are positioned in closer proximity to one another, as compared to the first 446 and second electrodes 448 as shown in FIG. 4C for the stylus pen in its relaxed state.

Upon application of an electric voltage across the first and second electrodes, the second portion of a stylus pen can thus decrease in diameter. This enables insertion of a stylus pen into a housing of a portable communion device such as a mobile phone, wherein the housing has an inner diameter that is smaller than the outer diameter of a stylus pen in its relaxed state. Upon insertion of the stylus pen comprising an EAP unit, the diameter of the stylus pen may thus decrease enabling the stylus pen to fit into a housing of the mobile phone.

FIGS. 5A and 5B illustrate in what way a stylus pen may change its shape upon insertion of it into a mobile phone, again according to a first embodiment of the present invention. FIG. 5A presents a stylus pen 500 having a first elongated portion 502 and a second portion 504 having a wider diameter than the first portion 502. The second portion typically comprises an EAP unit (not shown) that is able to change shape according to the strength of an applied electric voltage over two electrodes flanking an electro-active polymer. At the lower end of the elongated first portion, a tip 506 is formed, which tip is connected to the electro-active polymer via an electric conductor.

FIG. 5A also schematically shows a portable communication device 508 in the form of a mobile phone. The mobile phone has an outer wall 510 and an inner wall 512, which inner wall may form an elongated housing 512 within the mobile phone 508. The inner wall 512 also comprises a first electrode 514, which in this example is presented as an elongated sleeve 514. This first electrode 514 has connected to it one end of an electric conductor 516, of which the other end of the electric conductor 516 may be connected to a first pole of an electric voltage supply 518.

At the bottom of the housing 512 formed by the inner wall 512, an electricity conducting spring 520 may be provided, which spring can be compressed in a direction along its elongation axis. In FIG. 5A, the lower vertical end of the spring 520 is further connected a second pole of the electric voltage supply 518.

FIG. 5B illustrates the stylus pen from FIG. 5A inserted into the portable communication device from FIG. 5A, wherein the stylus pen is denoted 540 and the portable communication device 542. Upon insertion of the stylus pen 540 into the housing 544 of the mobile phone, the second portion 546 of the stylus pen is contracted.

By providing an electric voltage as supplied from the electric voltage supply 548, over the first electrode 550 of the inner wall 544 and the electricity conducting spring 552, the EAP unit of the second portion 546 is contracted upon insertion of the stylus pen 540 into the housing 544.

When the stylus pen 540 is inserted in the mobile phone being one example of a portable communication device 542, the tip 554 of the stylus pen 540 contacts the top of the spring 552 whereupon one potential from the electric voltage supply 548 is provided to one electrode of the electro-active polymer as comprised in the second portion 546 of the stylus pen 540. The electrode of the inner wall provides the other potential from the electric voltage supply 548 for provision of the electric voltage over the EAP unit causing the EAP unit to change in size.

It is thus clear that the stylus pen of FIG. 5A can be fitted into the cavity of FIG. 5A, after application of an electric voltage of a pair of electrodes of an EAP unit, as illustrated in FIG. 5B.

It is thus described that an EAP unit of the second portion 546 of the stylus member 540 can contract in the direction perpendicular to an elongation axis of said stylus member.

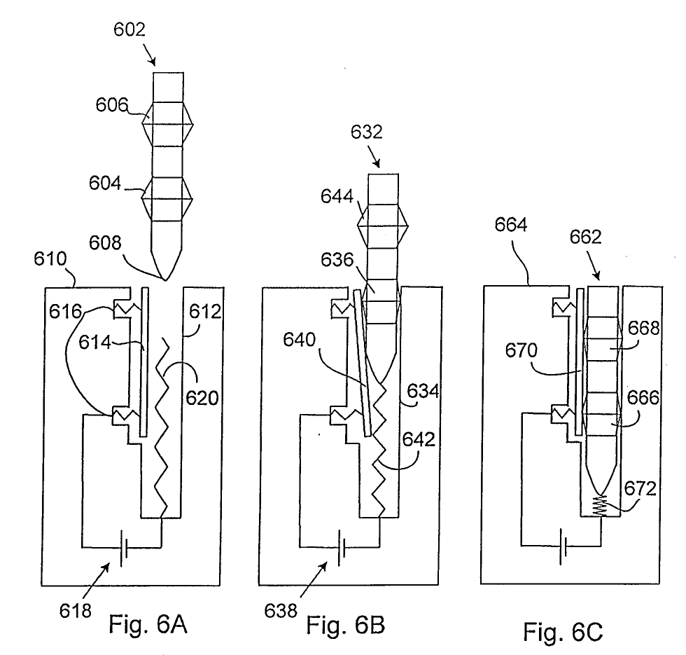

In the following a second embodiment of the present invention is explained, of which a stylus pen and a portable communication device are illustrated in FIGS. 6A-6C.

In FIG. 6A the stylus pen 602 may be provided with a first EAP unit 604 and a second EAP unit 606. A tip 608 may be provided at the lower end of the stylus pen.

The portable communication device as presented in FIG. 6A comprises an outer wall 610 and an inner wall 612, wherein the inner wall can form a housing, as earlier described above. The inner wall 612 also comprises an elongated electricity-conducting element 614. This element 614 may be provided with two resilient members 616 both of which can be mounted at the inner wall of the portable communication device 610. The electricity-conducting element 614 may be connected to a first pole of the electric voltage supply 618. This connection may be realized by connecting said pole to one resilient member 616 which resilient member may conduct electricity and therefore provide the electric potential from the pole of the electric voltage 618 to the conducting element 614. Also, a compressible spring can be provided at the bottom of the housing, which spring may be connected to the other pole of the electric voltage supply 618.

FIG. 6B illustrates a first stage of insertion of the stylus pen 632 into the housing as formed by the inner wall 634 of the mobile phone. Upon insertion of the stylus pen 632, the first EAP unit 636 is provided with the electric voltage of the electric voltage supply 638 via the electricity conducting element 640 and the compressible spring 642. It is also illustrated that the stylus pen 632 can displace the resiliently mounted electricity-conducting element 640 upon insertion. The second EAP unit 644 is however not affected and remains unchanged in shape.

FIG. 6C illustrates the stylus pen 662 further inserted into the mobile phone 664, wherein it can be seen that the first EAP unit 666 as well as the second EAP unit 668 have adopted a shape that is different from their relaxed respective shape. The second electro-active polymer unit 668 is thus also contracted after application of the electric voltage by the electricity conducting and resiliently mounted elongated element 670 and the compressible spring 672.

The EAP units as presented above have all been able to contract in thickness and expand in length and/or area. The EAP units have thus been mounted in such a way as to enable a change in size accordingly.

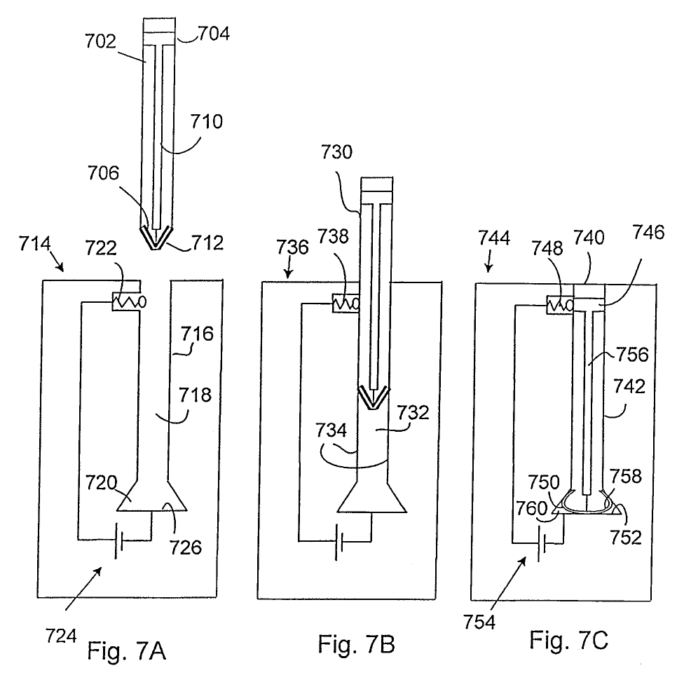

FIGS. 7A-7C illustrate a stylus pen and a portable communication device according to third embodiment of the present invention.

The stylus pen in FIG. 7A comprises an EAP unit that is provided in a rigid frame. Instead of expansion in the plane of the EAP unit, an electro-active polymer unit that is rigidly surrounded and mounted can only expand outside the plane of the relaxed electro-active polymer. FIGS. 7A-7C therefore provide one example of a third embodiment of the present invention.

FIG. 7A thus presents a stylus pen 702 which outer wall is substantially elongated in shape. In the outer wall of the stylus pen 702 a first electrode 704 may be provided. This electrode 704 may be connected to a first electrode 706 of an EAP unit 708 via an electricity conductor 710. A second electrode 712 of the electro-active polymer unit can be provided opposite to the first electrode 710, with an electro-active polymer provided in between said two electrodes, such that said electrodes flank the electro-active polymer of the EAP unit 708.

The corresponding portable communication device may be defined by an outer wall 714 and an inner wall 716, where the inner wall may define an elongated housing 718 as well as a locking indentation 720. At the inner wall 716 there may be provided an electricity conducting resilient member 722 protruding into the elongated housing 718 from the inner wall 716. The electricity conducting resilient member 722, which may be a spring, can be connected to one pole of an electric voltage supply 724. The other pole of the electric voltage supply 724 may be connected to the inside bottom 726 of the elongated housing 718.

FIG. 7B illustrates the stylus pen 730 upon insertion into the housing 732 as formed by the inner wall 734 of the portable communication device 736. At this stage the outer wall of the stylus pen 730 presses the resilient member 738 into the inner wall 734 of the portable communication device 736, as the stylus pen 730 is inserted into the housing 732.

FIG. 7C presents the stylus pen 740 fully inserted into the housing 742 as formed by the inner wall of the portable communication device 744. In this relative position of the stylus pen 740 and the portable communication device 744, electric contacting is established between the first electrode 746 of the stylus pen 740 and the electricity conducting resilient member 748. In this relative position electric contacting may also be provided between an outer electrode 750 of the EAP unit and a second electrode 752 that can be provided at the inside bottom of the elongated housing of the portable communication device 744.

The electricity conducting resilient member 748 may be connected to one pole of the electric voltage supply 754, and the second electrode 752 may be connected to the other pole of the electric voltage supply 754.

From the first pole a first potential can be provided, via an electric conductor 756 to the inner electrode 758 of the electro-active polymer unit. The second potential of the electric voltage can be provided via an electric conductor to the bottom electrode 752 in the housing.

For this reason, the electric voltage of the electric voltage supply 754 can be provided over the electro-active polymer of the EAP unit. The electro-active polymer may therefore change in shape and contract in the direction perpendicular to the two electrodes of the EAP unit, and expand perpendicular to the said direction. However, as the EAP unit is mounted rigidly at the stylus pen tip, the EAP unit is thus forced to expand sideways in a bending motion forming a diaphragm of the expanded EAP unit, wherein said diaphragm of the expanded EAP unit at least partially occupies the space of the locking indentation 760.

In this position, the stylus pen is thus locked inside the housing and the indentation 758 of the portable communication device. In this example of the electro-active polymer unit, it acts as a diaphragm that is bended outwards when expanded upon application of an adequate electric voltage in the order of kilo volts (kV).

It has thus been described that the stylus member comprises locking means, in the form of the rigidly mounted EAP unit 712, adapted to lock the stylus member 740 in a housing comprising locking means in the form of an indentation to receive the expanded EAP unit 712 upon application of an electric voltage.

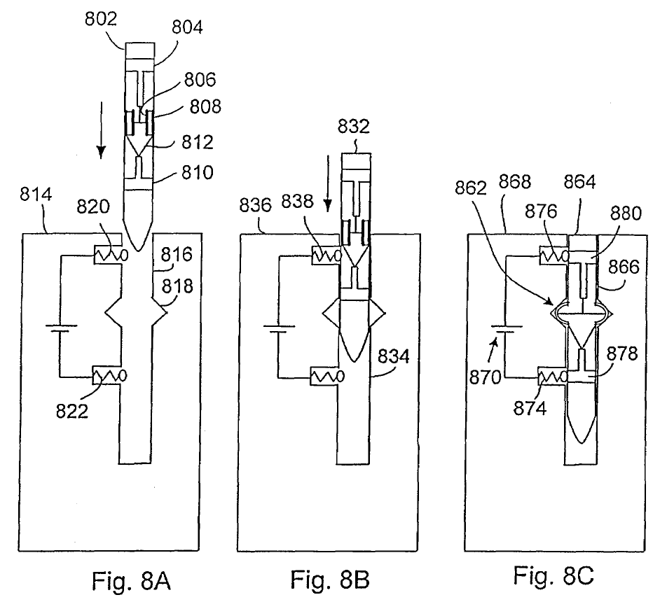

A fourth embodiment of the present invention, in which an electro-active polymer unit acts as a diaphragm is illustrated in FIGS. 8A-8C.

In FIG. 8A an elongated stylus pen 802 is presented comprising a first electrode 804 that can be arranged at the wall of the stylus pen. Via an electric conductor this first electrode 804 may be connected to a first electro-active polymer (EAP) electrode 806. A second EAP electrode 808 may be connected to the second electrode 810 of the stylus pen via the electric conductor 812. In between the first EAP electrode 806 and the second EAP electrode 808, an EAP may be provided which is arranged to change in shape upon allocation of an electric voltage over said first and second EAP electrodes.

Moreover, FIG. 8A also illustrates a portable communication device that comprises an outer wall 814 and an inner wall 816, wherein the inner wall can form a housing for the elongated stylus pen. The inner wall 816 also can also form indentations 818. The portable communication device may also comprise a first electricity conducting resilient member 820 and a second electricity conducting resilient member 822, said members each being connected to a pole of an electric voltage supply.

In FIG. 8B, it is illustrated an early stage of insertion of the stylus pen 832 into the housing 834 of the portable communication device 836. The outer wall of the stylus pen 832 presses the first electricity conducting resilient member 838 into the inner wall of the portable communication device, as the stylus pen is inserted into the housing 834.

FIG. 8C illustrates the expansion of the EAP unit 862 of the stylus pen 864 into the indentation as formed by the inner wall 866 of the portable communication device 868. The electro-active polymer is activated by the application of the electric voltage, as supplied by the electric voltage supply 870, over the two electrodes of the EAP unit, via the first electricity conducting resilient member 874 and the second electricity conducting resilient member 876 and the connecting electrodes 878, 880 of the stylus pen 864.

Due to that the EAP unit being provided in a rigid frame, the electro-active polymer is forced to bend or protrude out of the plane or surface as defined by the relaxed electro-active polymer.

The stylus pen 864 is thus locked in the housing 866 due to the electric voltage supply 870 supplying the EAP unit with the a sufficient electric voltage to cause the EAP to adopt an expanded diaphragm.

It has thus been explained that the stylus member 802, 832, 864 comprises locking means, in the form of the rigidly mounted EAP unit 862, adapted to lock the stylus member in a housing comprising locking means in the form of an indentation 818 to receive the expanded EAP unit 862 upon application of an electric voltage as provided by the voltage supply 870.

So far in the description various embodiments of the present invention have been described, wherein a stylus pen, being one example of a stylus member, has been arranged to be inserted into a housing of a portable communication device.

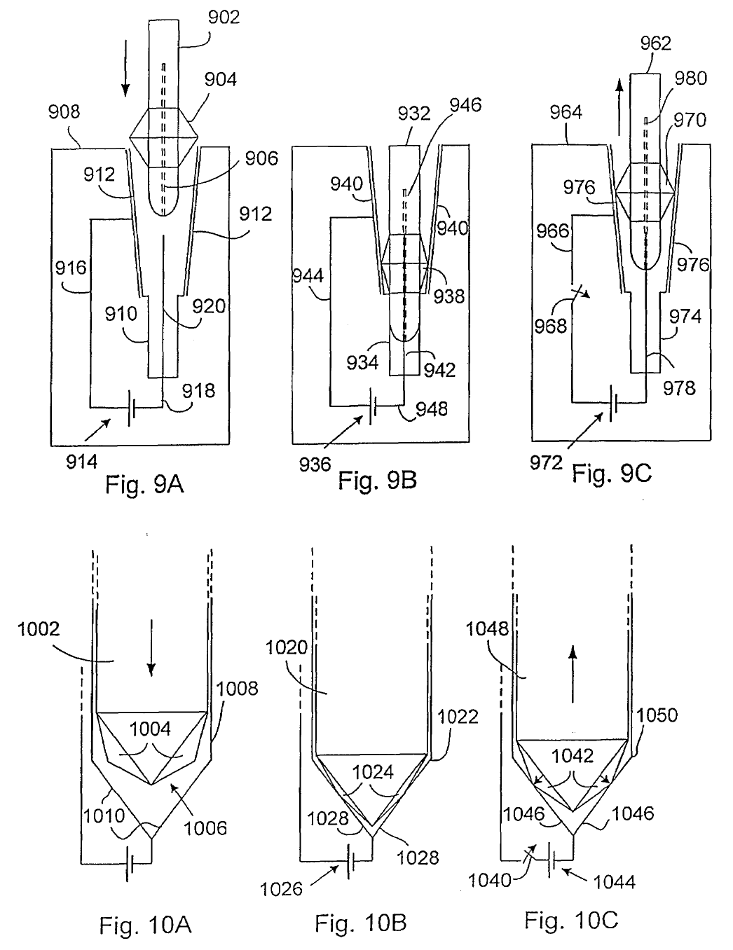

In the following FIGS. 9A-9C present a stylus pen and a corresponding portable communication device for both housing of the stylus pen inside the portable communication device, and as well for ejecting said stylus pen from the portable communication device. FIGS. 9A-9C accordingly illustrate one example of a fifth embodiment of the present invention.

The stylus pen 902 of FIG. 9A comprises an EAP unit 904, and a groove or track 906 that is preferably formed longitudinally in the elongated stylus pen 902. This groove or track 906 can be made of an electric conductor, but at least has the capability to conduct electricity.

The portable communication device, such as a mobile phone, comprises an outer wall 908 and an inner wall 910. Said inner wall may moreover comprise one or two sloping walls 912 or alternatively, for a symmetric application, a conical sleeve. These sloping walls 912 or this conical sleeve is an electric conductor. One pole of the electric voltage supply 914 may be connected to at least one of the sloping walls or the sleeve via a first electric conductor 916. The other pole of the electric voltage supply 914 may be connected via a second electric conductor 918 to an electric conducting elongated element 920. This electricity conducting elongated element 920, which may be realized as a pin, may be arranged at the bottom of the housing of portable communication device and oriented along the elongation axis of elongated housing towards the opening of the housing.

FIG. 9B shows the stylus pen 932 fully inserted into the housing as defined by the inner wall 934 of the mobile phone, being one example of the portable communication device. As the stylus pen 932 is inserted in the housing, the electric voltage as supplied from the electric voltage supply 936, can be fed to the EAP unit 938 via the sloping walls 940 and the electricity conducting elongated element 942. The EAP unit 938 may thus be contracted in a dimension perpendicular to the elongation axis of the stylus pen 932. It is illustrated that the EAP unit 938 can change in size such that the stylus pen 932, that comprises an EAP unit 938, can fit into the housing formed by the inner wall 934 of the mobile phone.

FIG. 9B illustrates the stylus pen 932 in its bottom position in the housing of the mobile phone.

The stylus pen 932 is thus contracted due to the applied electric voltage over the EAP unit 938. It is thus important that the electric circuit as formed by the first electric conductor 944, the sloping wall 940, the EAP unit 938, the groove or track 946 of the stylus pen, the electricity conducting elongated element 942, the second electric conductor 948, and the electric voltage supply 936, together form a closed circuit, allowing the voltage to be fed from the electric voltage supply 936 to the EAP unit 938.

Down below it is described the effect of an opening of the closed circuit. In FIG. 9C ejecting of the stylus pen 962 from the mobile phone 964 is hence presented.

As illustrated in FIG. 9C, the first electric conductor 966 may be connected to a switch 968. By opening this switch 968, the EAP unit 970 can no longer be fed with an electric voltage from the electric voltage supply 972. As a consequence, the EAP unit 970 relaxes from its contracted shape and expands in the dimension perpendicular to the elongation axis of the stylus pen 962. As the EAP unit 970 expands, the stylus pen 962 is ejected from the housing 974. This is due to a pressing force as exerted by the expanding EAP unit 970 towards the sloping wall or walls 976, or even conical sleeve. As the exerted force typically is not be perpendicular to the surface of the sloping wall 976, there is a component of the force which acts in the plane of the sloping wall 976. This force component may be large enough to enable the outer wall of the EAP unit 970 to slide along the sloping wall 976 or walls, such that the stylus pen 962 is pushed out of the housing 974.

Due to the expansion of the EAP unit 970 in the housing 974, the stylus pen 962 can no longer remain positioned in its fully inserted state in the housing 974, but is ejected from the housing 974.

Opening of the circuit is preferably initiated by a user pressing a button causing, for instance the switch 968 to open, as illustrated in FIG. 9C.

In FIG. 9C it is illustrated the ejecting of the stylus pen 962 from the housing 974 of the mobile phone upon switching off the applied voltage. As the EAP unit 970 changes its shape and size according to the strength of the applied electric voltage of said EAP unit 970, the shape and size can also be changed by decreasing the applied voltage.

It has thus been explained that the stylus member 902, 932, 962 comprises contracting means, in the form of the EAP unit 904, adapted to contract the stylus member upon insertion into the housing 910. The portable communication device comprises means for contacting said stylus member, said means comprising at least one electrically conducting sloping wall 912, 940, 976 against which the EAP unit 904, 938, 970 may contact and thus contract upon insertion.

According to an alternative example, the applied voltage may thus be decreased upon which the EAP unit 970 expands causing the stylus pen 962 to slide out of the housing 974 of the mobile phone 964. As the stylus pen 962 is slid out of the mobile phone, the electricity conducting elongated element 978 is also slid out of the track or groove 980 as comprised in the stylus pen 962. The speed with which the stylus pen 962 is slid out, is hence dependent of the decrease in the applied electric voltage.

A user may hence insert a stylus pen into a housing of a mobile phone, according to the description, and press a button upon which the stylus pen can be fully or at least partially ejected from said housing. The distance with which the stylus pen is ejected from the housing should be enough to enable a user to grip the stylus pen, to enable the user to fully pull it out of the housing in case it partially remains inside the housing after ejection.

The user may further use the pen to, for instance, activate the pressure-sensitive display or screen by pressing or writing on said display or screen with said stylus pen.

According to a sixth embodiment of the present invention, an alternative embodiment of ejecting the stylus pen out of the portable communication device is schematically presented in FIGS. 10A-10C.

The stylus pen 1002 according to this embodiment may have at least one EAP unit 1004 provided in the tip region 1006 of the stylus pen.

The inner wall 1008 of the mobile phone according to this embodiment may comprise a sloping portion 1010 at the bottom of the elongated housing. The inner wall 1008 at the bottom may comprise two sloping walls 1010 or may be comprised of a conical wall with the tip of the wall defining the very bottom of the housing.

As the stylus pen 1002 is inserted into the housing 1008, the outer surface of the tip of the stylus pen 1002 may reach the sloping bottom wall 1010, upon which an electric voltage can be provided over the EAP unit 1004.

FIG. 10B presents the stylus pen 1020 in the lower position in the housing 1022 of the mobile phone, with the EAP unit(s) 1024 of the stylus pen 1020 being contracted, enabling the stylus pen 1020 to be fully inserted into the housing 1022. The EAP unit 1024 may contract in thickness and expand in the plane of the electrodes of the EAP unit 1004, in a way similar as previously described. This is enabled by the electric voltage supply 1026 that activates the EAP unit 1024 via the sloping wall 1028 of the stylus pen 1020.

However, by opening a switch 1040 and thereby breaking the circuit that is providing the EAP unit 1042 with an electric voltage, as supplied by the electric voltage supply 1044, the EAP unit 1042 expands upon which the outer walls of the EAP unit 1042 press towards to sloping wall or walls of the bottom portion 1046 of the housing, as illustrated in FIG. 10C. As an effect the stylus pen 1048 will be at least partially ejected from the housing 1050. The distance with which the stylus pen 1048 is ejected may be adapted to be enough for a user to grip the stylus pen 1048 for subsequent usage.

It has now been described that the stylus member 1002, 1020, 1048 comprises contracting means, in the form of EAP unit 1004, 1024, 1042 adapted to contract upon insertion of the stylus member into the housing. Also, the stylus member comprises ejecting means in the form of the EAP unit 1004, 1024, 1042. The housing 1008, 1022, 1050 also comprises contracting means in the form of the sloping walls 1010, 1028, 1046. In addition, the housing comprises ejecting means in the form of the sloping walls 1010, 1028, 1046 and the switch 1040, upon activation of which causes the stylus member 1002, 1020, 1048 to eject from the housing 1008, 1022, 1050.

In the following, a seventh embodiment of the present invention is presented, for which the stylus pen and the corresponding portable communication device are adapted for housing the stylus pen and enabling the stylus pen to be ejected from the portable communication device.

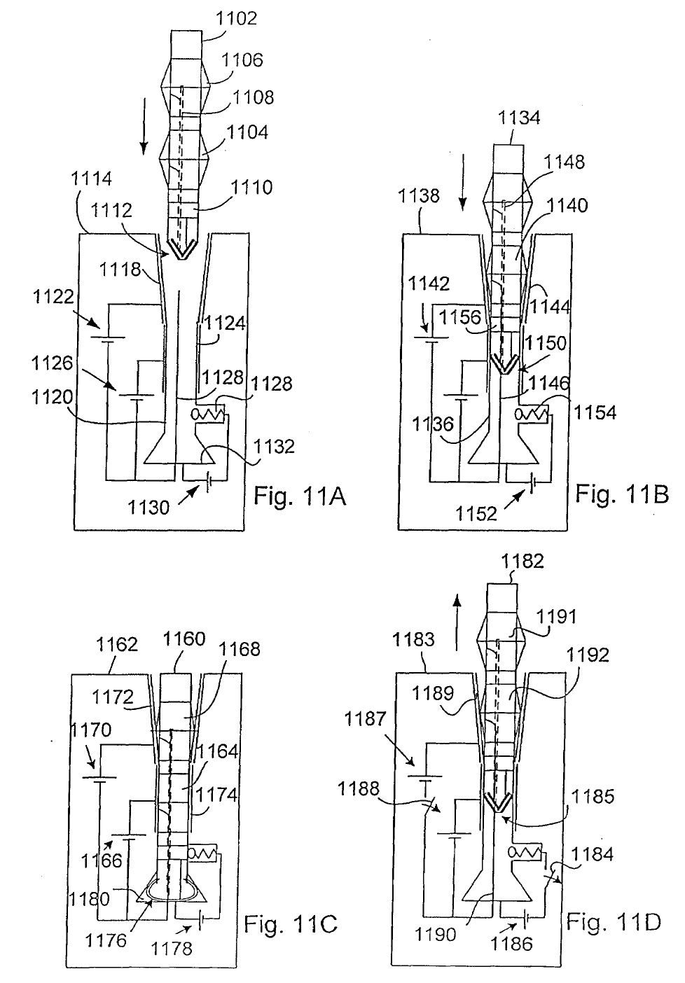

FIGS. 11A-11D illustrate such a stylus pen and mobile phone, being one example of a portable communication device. FIG. 11A illustrates the stylus pen 1102 as comprising a first EAP unit 1104, a second EAP unit 1106, a groove or track 1108, a surface electrode 1110 and a third EAP unit 1112. The respective inner electrode of the first EAP 1104 and the second EAP 1106 may be connected to the electricity conducting groove or track 1108. The surface electrode 1110 may be connected to the inner electrode of the third EAP unit 1112. The outer electrode of the first EAP 1104 may be insulated with respect to the outer electrode of the second EAP.

The mobile phone 1114 comprises an inner wall 1116 having a sloping portion 1118 and a substantially straight elongated portion 1120. The sloping portion 1118 may comprise an electrode connected to one pole of a first electric voltage supply 1122, where the other pole of said supply 1122 is connected to an elongated electricity conducting element 1124, such as a pin, within the housing of the mobile phone 1114. Also, the substantially straight portion 1120 of the inner wall may comprise an electrode that can be connected to one pole of a second voltage supply 1126. The other pole may be connected to the elongated electricity conducting element 1124, directed along the elongated housing. In addition, the inner wall 1136 of the mobile phone 1114 may also comprise a electricity conducting resilient member 1128 that may be connected to a first pole of the third voltage supply 1130, of which a second pole may have a connection via an electric conductor to the electric conducting inner bottom 1132 of the housing.

FIG. 11B illustrates the stylus pen from FIG. 11A being partially inserted into a mobile phone. In FIG. 11B this stylus pen 1134 may thus be inserted a distance into the housing 1136 of the mobile phone 1138. The first EAP unit 1140 has decreased in size due to the voltage, as supplied by the first voltage supply 1142, whereby the voltage is applied over the first EAP unit 1140 via the conducting sloping wall 1144 and the elongated electrically conducting element 1146, as provided in the housing. Upon insertion of the stylus pen 1134 into the housing 1136, the elongated electrically conducting element 1146 may be inserted into the groove or track 1148 of the stylus pen 1134, establishing an electric contact.

A potential of the first electric voltage supply 1142 may thereby be provided to an outer electrode of the first EAP unit 1140. A second potential may be provided to the inner electrode of the EAP unit 1140, via the track or groove 1148.

An electric voltage may thus be provided to the first EAP unit 1140, upon which the EAP unit 1140 may contract, enabling the stylus pen 1134 to be further inserted into the housing 1136.

It may be noted that the outer electrode of the first EAP unit 1140 is fed with a potential at the time the outer electrode of the first EAP unit 1140 contacts the sloping wall 1144, whereas the inner electrode of the first EAP unit 1140, is fed a potential via the groove or track 1148 at the time said track or groove 1148 is contacted to the elongated electrically conducting element 1146.

In FIG. 11B it is also illustrated the presence of a third EAP unit 1150 that may be mounted in a rigid frame a the tip of the stylus pen 1134. Also, there is provided a third voltage supply 1152 and a electrically conducting resilient member 1154 arranged in the housing 1136 to enable feeding of a voltage to the third EAP unit 1150 at the stage when the stylus pen 1134 is fully inserted in the housing 1136.

In FIG. 11C, the stylus pen 1160 has been fully inserted into the housing of the mobile phone 1162. It is illustrated that the first EAP unit 1164 may now be fed with an electric voltage from a second voltage supply 1166, whereas the second EAP unit 1168 may be fed with a voltage from the first voltage supply 1164. As the stylus pen 1160 was inserted, the first EAP unit 1164 was first fed by a voltage from the first voltage supply 1170, but as the outer wall of the first EAP unit 1164 passed the sloping wall 1172 and contacted the substantially straight wall 1174, the first EAP unit 1164 was fed by the second voltage supply 1166. It can also be noted that the first EAP unit 1174 may be much or fully contracted, where the second EAP unit 1168 may be contracted to a lesser extent due to the sloping shape of the sloping walls 1172 providing a widened entrance of the housing of the mobile phone 1162.

Moreover, FIG. 11C further presents a third EAP unit 1176 provided near the tip of the stylus pen 1160 in an activated form. The third EAP unit 1176 may be activated by a voltage by the third electric voltage supply 1178.

This third EAP unit 1176 is preferably mounted in a rigid frame allowing expansion only out of the plane of the third EAP unit 1176 itself. Hence the third EAP unit 1176 contracts in thickness and expands in length and area, whereupon said third EAP unit 1176 adopts a size of an activated curved diaphragm protruding into the indentation 1180 as formed by the inner wall of the mobile phone. The stylus pen may thus be locked inside the housing.

In FIG. 11D a stylus pen 1182 and mobile phone 1183 are illustrated, wherein the stylus pen 1182 is slid out of the housing of the mobile phone 1183. A user the mobile phone 1183 may open a switch 1184 within the circuit that provides the third EAP unit 1185 with an electric voltage. The user may for instance press a button, upon which the voltage, that may be supplied by the third voltage supply 1186, is switched off. The third EAP unit 1185 then relaxes and adopts a planar form, as previously described and as illustrated in FIGS. 11A and 11B. Moreover, the user input may affect the voltage as supplied from the first voltage supply 1187, by opening a switch 1188 within a circuit that provides the sloping wall 1189 and elongated electrically conducting element 1190 with an electric voltage.

By switching off or decreasing the voltage as applied to the second EAP unit 1191, the second EAP unit accordingly relaxes and adopts a size as shown in FIGS. 11A and 11B. As a consequence, the outer wall of the second EAP unit 1191 presses against the sloping wall 1189, which results in an out-wards directed force being applied to the stylus pen 1182 forcing the stylus pen 1182 to at least partially be ejected from the housing. As visualized in FIG. 11D, the outer wall of the first EAP unit 1192 may also reach the sloping wall 1189 as the stylus pen is ejected. As the switch 1188 already can be opened, the first EAP unit 1192 may be fed with a nil voltage, for which reason the first EAP unit 1192 can expand and consequently apply a forces on the sloping walls 1189 of the mobile phone 1183. In summary, the second EAP unit may first apply a force on the sloping wall or walls 1189 upon opening of the switch 1188. Subsequently, the first EAP unit 1192 may apply a force on the sloping wall or walls 1192, as the stylus pen 1182 has come partially out of the housing.

It has now been described that the stylus member 1102, 1134, 1160, 1182 comprises contracting means, in the form of the first and the second EAP units, 1104 and 1106, respectively. Said EAP units have also been described to function as ejecting means applying a force on the sloping walls upon switching of the voltage supplying the EAP units with their respective voltage. The stylus member also comprises locking means in the form of the third rigidly mounted EAP unit, 1112, 1150, 1176, 1185.

The housing 1114, 1138, 1162, 1183 also comprises contracting means in the form of the sloping walls 1118, 1144, 1172, 1189. In addition, the housing comprises ejecting means in the form of said sloping walls 1118 1144, 1172, 1189 and the switch 1188, upon activation of which causes the stylus member 1102, 1134, 1160, 1182 to eject from the housing. Moreover the housing comprises locking means for locking of the stylus pen inside the housing as provided therefor, where said locking means comprises the indentation 1132, 1180. the portable communication device also comprises releasing in the form of the switch 1184, upon which opening the stylus pen is released from the housing.

In this way, a housing for a stylus pen can be provided, wherein the housing may provide a locking mechanism for the stylus pen, as well as an ejecting mechanism for extracting the stylus pen out of the housing.

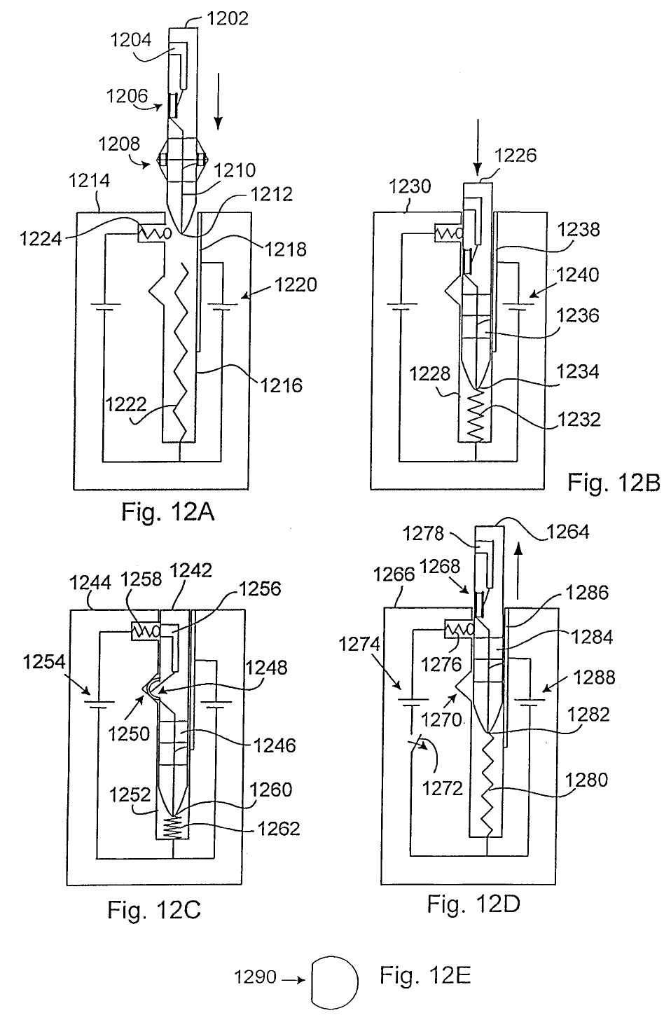

An alternative embodiment of a retain-release or lock-release mechanism is presented by an eighth embodiment of the present invention, as illustrated in FIGS. 12A-12D. According to this embodiment the force for pushing or ejecting the stylus pen may be provided by a spring, such as a compression spring.

For comparison, the force for ejecting the stylus pen according to the seventh embodiment was provided by the interaction between an expanding EAP unit and at least one sloping wall.

Returning to FIGS. 12A-12D, FIG. 12A illustrates a stylus pen 1202 comprising a first surface electrode 1204 that may be connected to a rigidly mounted first EAP unit 1206 of the stylus pen 1202. The stylus pen may also comprise a second EAP unit 1208 that is allowed to expand in the plane of the EAP unit. The tip 1202 of the stylus pen has an electric conductor 1210 connected to it, which conductor further may connect to the inner electrode of the second EAP unit 1208 as well as to the outer electrode of the first EAP unit 1206.

It is obvious that the electric conductor 1210 may alternatively be connected to the inner electrode of the first EAP unit 1206 and the surface contact 1204 connected to the outer electrode of the first EAP unit 1206.

In general, the explicit conductors and connections may be arranged in different realizations as long as the pertinent EAP units are provided with a respective electric voltage, according to each respective embodiment and as described in the current text.

The portable communication device 1214 may comprise an inner wall 1216 having an electrode 1218 for contacting the outer wall of the second EAP unit 1208. The electrode 1218 may further be connected to one pole of the first voltage supply 1220, which other pole can be connected to the electrically conducting spring 1222. This electricity conducting spring 1222 can be adapted to contact the tip 1212 of the stylus pen 1202 upon insertion of the stylus pen 1202 into the housing defined by the inner wall 1216. As will be described down below, the first voltage supply 1220 may thus be responsible for activating the second EAP unit 1208 upon inserting the stylus pen 1202 into the housing.

Moreover, the inner wall 1216 may also comprise a resilient member 1224, mounted so as to be able to protrude from the inner wall 1216 into the opening of the housing in a radial or at least lateral direction. This resilient member 1224 may be adapted to contact the surface electrode 1204 of the stylus pen 1202 upon an advanced insertion of the stylus pen 1202.

FIG. 12B illustrates the stylus pen 1226 inserted a distance into the housing as defined by the inner wall 1228 of the mobile phone 1230. The resilient spring 1232 may contact the tip 1234 of the stylus pen 1226, whereas the outer wall of the second EAP unit 1236 may contact the electrode 1238 of the inner wall 1228. A voltage is thus provided by the first voltage supply 1240 to the second EAP unit 1236 for which reason said second EAP unit 1236 can be activated and contract in thickness and expand in area and length. Accordingly, the stylus pen 1226 can for this reason fit into the housing that has a narrower cross section than the widest cross-section, i.e. the one at the center of the second EAP unit, of the relaxed stylus pen 1202 in FIG. 12A.

FIG. 12C illustrates a relative position of the stylus pen 1242 in the housing of the mobile phone 1244, for which the stylus pen 1242 is fully inserted in the housing. In addition to the second EAP unit 1246 being activated, the first EAP unit 1248 is also activated in FIG. 12C.

As the first EAP unit 1248 may be mounted rigidly in the stylus pen 1242, this first EAP unit 1248 may be forced to protrude out of the plane of the EAP unit 1248, by forming a diaphragm. In FIG. 12C the first EAP unit may form a diaphragm into the indentation 1250 of the inner wall 1252, upon activation of the first EAP unit 1248.

Activation of the first EAP unit 1248 may be accomplished by applying an electric voltage, which may be supplied by the second voltage supply 1254, over said EAP unit 1248. This may be realized by providing electric contact between the surface electrode 1256 and the resilient member 1258, and an electric contact between the tip 1260 of the stylus pen 1242 and the resilient spring 1262, with the voltage supply 1254 connected as illustrated in FIG. 12C. By providing an electric voltage to the first EAP unit 1248, the EAP unit may thus be activated and protrude into the indentation 1250.

With the stylus pen positioned in its inner position in the housing of the mobile phone, the user of the phone may now initiate ejecting the stylus pen from the housing of the mobile phone.

FIG. 12D illustrates the stylus pen 1264 being ejected from the mobile phone 1266, after switching off the voltage that was activating the first EAP unit 1268 and thus locking the stylus pen 1264 into the indentation 1270 of the mobile phone 1266. Switching off the voltage may be accomplished by a user initiating opening a switch 1272 connected in a circuit comprising the second voltage supply 1274 supplying the voltage to the first EAP unit 1268 via the resilient member 1276 and surface electrode 1278, and via the resilient spring 1280 and the tip 1282 of the stylus pen 1264.

By switching off the voltage from the first EAP unit 1268, said first EAP unit may relax and adopt a non-strained planar shape, as illustrated in FIG. 12D.

In the same figure, it is illustrated that the stylus pen 1264 may be ejected from the housing by the force as exerted by the resilient spring 1278, acting on the tip 1282 of the stylus pen 1264.

When the stylus pen 1262 further leaves the housing, the electric circuit involving the outer wall of the second EAP unit 1284, the electrode of the wall 1286, the first voltage supply 1288, the resilient spring 1280 and the inner wall of the second EAP unit 1284, may be broken, as the contact between the outer wall of the second EAP unit 1284 and the electrode of the wall 1286 may break. As a result, the second EAP unit 1284 may change in shape and adopt a relaxed form, wherein the circumference around the outer wall of the second EAP unit 1284 may be larger than the inner circumference of the inner wall of the housing of the mobile phone 1266.

It has here been described that the stylus member 1202, 1226, 1242, 1264 comprises contracting means, in the form of the second EAP unit, 1208. The stylus member also comprises locking means in the form of the rigidly mounted first EAP unit, 1206.

The housing 1214, 1230, 1244, 1266 also comprises contracting means in the form of the wall electrode 1218, 1238, 1286. In addition, the housing comprises ejecting means in the form of the electrically conducting spring 1222, 1232, 1262, 1280. The housing moreover also comprises releasing locking and releasing means in the form of the indentation 1250, 1270 adapted to receive the rigidly mounted EAP unit when activated. When opening the switch 1272, being one form of releasing means, the stylus member is ejected by said ejecting means 1222, 1232, 1262, 1280.

According to this embodiment of the present invention, the stylus pen is displayed as being provided with the surface electrode 1278 on one side of the outer wall, with the resilient member 1276 provided in the inner wall of the mobile phone 1266. For this reason the stylus pen 1264 may be circular asymmetric, since the angular position of the stylus pen in the housing can be of relevance for the proper function in a few examples. The stylus pen 1264 may, of course, however have a two-fold symmetry in the displayed embodiment of FIG. 12D.

It should be emphasized that the stylus pens as presented in the various embodiments may be circular symmetric, that is that their cross sections perpendicular to the elongation axis may be circular symmetric. The elongation axis for the respective stylus pen then becomes a symmetry axis. These stylus pens that may be symmetric are the ones that are presented in FIGS. 4-10, illustrating stylus pens according to the first to the sixth embodiments of the present invention.

Many more shapes may be utilized for the stylus pens, which may bring new features and aspects over the symmetric ones.

The stylus pen as presented in FIGS. 11A-11D, illustrating a seventh embodiment may, for instance, be substantially symmetric but may alternatively be asymmetric. The stylus pen as schematically illustrated in FIGS. 12A-12E, according to the eighth embodiment of the present invention, are presented as being asymmetric.

For an asymmetric stylus pen or cross-section, various electrically conducting tracks and grooves may be provided, for instance, at different angular intervals viewing along the elongation axis of the stylus pen. FIG. 12E illustrates one cross-section 1290 of the stylus pen, out of a number of possible cross-sections of said stylus pen. The presented shape of the cross-section 1290 has a two-fold symmetry.

Moreover, the EAP portion as for instance illustrated in FIG. 4A, may comprise one or more EAP units. In the case the stylus pen as presented is circular symmetric, the presented illustration depicts one symmetric EAP units. A lateral cross section of this symmetric stylus pen, as presented, may then give the impression of the stylus pen comprising two separate EAP units, despite the fact that the stylus member, in the form of a stylus pen, in reality comprises only a singular circular symmetric EAP unit.

This aspect of the number of EAP units applies generally to the presented embodiments, with the exception of embodiment eight, as illustrated in FIGS. 12A-12D, wherein the first EAP portion 1206 is illustrated to comprise only a singular EAP unit.

It is emphasized that the technical features of the presented embodiments may be combined, possibly creating new embodiments. The alternative embodiments, as presented herein are thus a few examples only.

These presented embodiments are hence non-limiting examples. The scope of the present invention, however, is only limited by the subsequently following claims.

It comes without saying that the at least some embodiments come with a number of advantages of which one is providing an ergonomic stylus pen which would facilitate the usage of the stylus pen.

Another advantage of at least some embodiments is that a stylus pen is provided which is wider than common stylus pen further facilitating the usage of the stylus pen.

Yet another advantage is that the housing as provided for the stylus pen is smaller, preventing larger objects to be inserted or by mistake be positioned in the housing, which could hinder the insertion of appropriate stylus pen.

1. A stylus member for a portable communication device, said stylus member comprising:
a body portion being elongated along an elongation axis, and
at least a first electro-active polymer (EAP) portion arranged at said body portion, said at least first EAP portion comprising an EAP unit comprising an electro-active polymer, a first electrode, and a second electrode, wherein the first and second electrodes flank the EAP,
wherein the body portion of the stylus member further comprises an electric conductor connecting the first electrode of the EAP unit and a first electric contact of the body portion of the stylus member,
and wherein the EAP unit is adapted to change in size upon application of an electric voltage over the first and second electrodes of the EAP unit.

2. The stylus member according to claim 1, wherein the EAP unit is arranged to contract in the direction perpendicular to the elongation axis of the stylus member, upon application of the electric voltage.

3. The stylus member according to claim 1, wherein the stylus member comprises locking means adapted to lock the stylus member in a housing provided therefor.

4. The stylus member according to claim 3, wherein the stylus member further comprises releasing means adapted to release a locked stylus member from the housing provided therefor.

5. The stylus member according to claim 3, wherein the locking means comprises an EAP unit that is rigidly mounted on the stylus member and arranged to protrude in a direction perpendicular to the elongation axis of the stylus member, upon application of the electrical voltage.

6. The stylus member according to claim 2, wherein the stylus member further comprises ejecting means adapted to eject the stylus member from a housing provided therefor.

7. The stylus member according to claim 6, wherein the ejecting means comprises an EAP unit that is arranged to expand from a contracted EAP state, upon disconnection of an electrical voltage over said EAP unit.

8. The stylus member according to claim 1, wherein the stylus member is a stylus pen.

9. A portable communication device comprising:
an outer surface, and
an inner surface forming an elongated housing, wherein said inner surface comprises at least a first electrode,
wherein the inner surface further comprises a second electrode, and wherein the first and second electrodes are arranged to be connected to a first and a second pole, respectively, of an electric voltage supply, and wherein the housing, as formed by the inner surface, is adapted to receive a stylus member according to claim 1.

10. The portable communication device according to claim 9, further comprising means for contracting a stylus member upon insertion of the stylus member according to claim 2 in the housing, said means comprising a first electrode, a second electrode and an electric voltage supply, and wherein the first and second electrodes are adapted to contact the first electric contact of the body portion and the second electrode of the EAP unit, respectively.

11. The portable communication device according to claim 9, further comprising ejecting means adapted to eject a stylus member according to claim 6, inserted in the housing.

12. The portable communication device according to claim 9, wherein ejecting means comprises at least one electrically conducting sloping wall and an electrical switch adapted to disconnect the electrical voltage supply from the EAP unit, as initiated by a user of the portable communication device, such that the EAP unit upon relaxation pushes towards the at least one electrically conducting sloping wall, thereby obtaining a force directed towards the entrance of the housing, forcing the stylus member according to claim 7 to eject from the housing.

13. The portable communication device according to claim 11, wherein the ejecting means comprises a compressing spring ejecting the stylus member according to 2 from the housing.

14. The portable communication device according to claim 9, further comprising locking means adapted to lock a stylus member according to claim 3, upon insertion of the stylus member into the housing.

15. The portable communication device according to claim 14, wherein the locking means comprises an indentation in the inner surface, said indentation being adapted to receive the protrusion of the stylus member according to claim 5.

16. The portable communication device according to claim 9, wherein the portable communication device is a mobile phone.
